(19) United States
(12) Patent Application Publication
(10) Pub. No.: US 2020/0031189 A1
(43) Pub. Date: Jan. 30, 2020

(54) VARIABLE RATE LEAF SPRING SUSPENSION

(71) Applicant: John Prikkel, III, Dayton, OH (US)

(72) Inventor: John Prikkel, III, Dayton, OH (US)

(21) Appl. No.: 16/590,679

(22) Filed: Oct. 2, 2019

Related U.S. Application Data
(63) Continuation of application No. PCT/US2018/025787, filed on Apr. 3, 2018.
(60) Provisional application No. 62/480,673, filed on Apr. 3, 2017.

(51) Int. Cl. B60G 17/027; B60G 11/04

(52) U.S. Cl. CPC B60G 17/0275; B60G 11/04; B60G 2202/112; B60G 2500/22; B60G 2202/32; B60G 2204/121; B60G 2202/24

(57) ABSTRACT

A suspension system comprises a leaf spring and a slider box. The leaf spring is a cambered leaf spring and comprises a first end with a first coupler that couples to a first point on a frame of a vehicle and a second end. Further, a pivot point resides between the first end and the second end. The slider box comprises a coupler that fixedly couples the slider box to a second point on the frame of a vehicle. Further, an opening of the slider box accepts the second end of the leaf spring such that the leaf spring slides in the slider box when the leaf spring is flattened. Moreover, the spring box comprises a foreshortening mechanism that changes an effective length of a portion of the leaf spring between the second end of the leaf spring and the pivot point of the leaf spring as the leaf spring flattens.

### CROSS REFERENCE TO RELATED APPLICATIONS

This application is a bypass continuation of International Application No. PCT/US2018/025787, filed Apr. 3, 2018, entitled VARIABLE RATE LEAF SPRING SUSPENSION, which claims the benefit of U.S. Provisional Patent Application Ser. No. 62/480,673, filed Apr. 3, 2017, entitled VARIABLE RATE LEAF SPRING SUSPENSION, the disclosures of which are hereby incorporated herein by reference.

### BACKGROUND

Various aspects of the present invention relate generally to vehicle suspensions and more specifically to vehicle suspensions incorporating a leaf spring, where a spring rate of the leaf spring may need to vary.

Currently truck and van suspensions use a Hotchkiss suspension, which is part of the Hotchkiss drive and was the dominant form of power transmission for front-engine, rear-wheel drive layout. This suspension uses a leaf spring, usually steel and in some cases composite fiberglass, epoxy, other polymer-like urethane, and combinations thereof.

### BRIEF SUMMARY

According to aspects of the present invention, a suspension system comprises a leaf spring and a slider box. The leaf spring is a cambered leaf spring and comprises a first end with a first coupler that couples to a first point on a frame of a vehicle and a second end. Further, a pivot point resides between the first end and the second end. The slider box comprises a coupler that fixedly couples the slider box to a second point on the frame of a vehicle. Further, an opening of the slider box accepts the second end of the leaf spring such that the leaf spring slides in the slider box when the leaf spring is flattened. Moreover, the spring box comprises a foreshortening mechanism that changes an effective length of a portion of the leaf spring between the second end of the leaf spring and the pivot point of the leaf spring as the leaf spring flattens.

### BRIEF DESCRIPTION OF THE SEVERAL VIEWS OF THE DRAWINGS

FIG. 1 is a diagram illustrating a suspension system for a vehicle, according to various aspects of the present disclosure;

FIG. 2 is a diagram of the slider box coupled to a frame of a vehicle, according to various aspects of the present disclosure;

FIG. 3 is a diagram illustrating a leaf spring in a first position in a slider box, according to various aspects of the present disclosure;

FIG. 4 is a diagram illustrating the leaf spring in a second position in the slider box, according to various aspects of the present disclosure;

FIG. 5 is a diagram illustrating another embodiment of the slider box, according to various aspects of the present disclosure; and

FIG. 6 is a diagram illustrating a charging port for a variable rate leaf spring suspension, according to various aspects of the present disclosure.

### DETAILED DESCRIPTION

According to various aspects of the present disclosure, a mechanism to create a variable rate leaf spring using a regular leaf spring is provided. Basically, the spring rate of a leaf spring is dependent on the length of the leaf spring, among other things. For example, a shorter leaf spring will have a higher spring rate than a longer leaf spring. According to aspects of the present disclosure, a slider box is mounted to a vehicle, and an end of the leaf spring is placed inside the slider box. As the spring flattens under a load, the spring extends further into the slider box, which reduces an amount of spring outside of the slider box or the length of the spring between a coupling point to the vehicle and the pivot point. As such, the spring is foreshortened, which increases the spring rate of the spring. Thus, a regular leaf spring may be transformed into a variable rate leaf spring with the addition of the slider box.

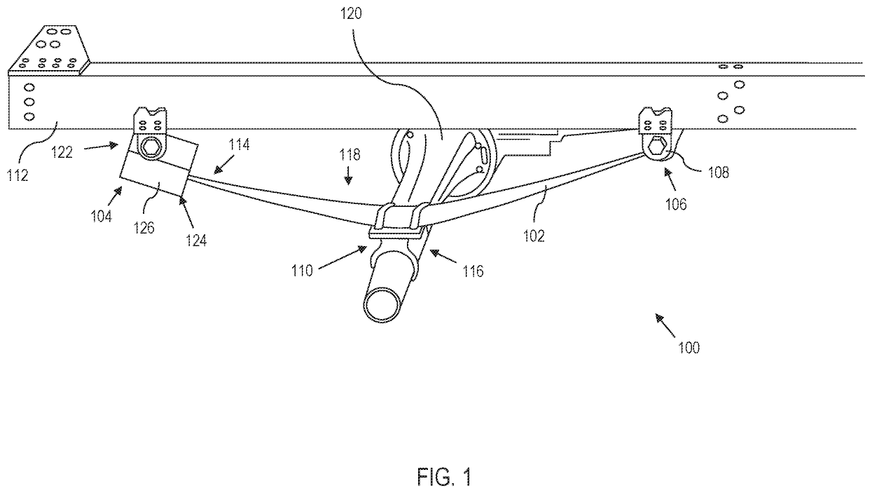

Turning to the figures, and in particular to FIG. 1, a suspension system 100 is shown. The suspension system 100 includes a leaf spring 102 and a slider box 104. The leaf spring may be a leaf spring with a fixed spring rate. Thus, the leaf spring 102 may be single layered or multilayered. A first end 106 of the leaf spring 102 includes a coupler 108 that couples to a first point 110 on a frame 112 of a vehicle. Moreover, the leaf spring 102 includes a second end 114 that couples to the slider box 104, as discussed in greater detail below. Further, the leaf spring 102 includes a pivot point 116 between the first end 112 and the second end 116, along with a camber 118. As shown, the leaf spring 102 is coupled to an axle 120 of the vehicle near the pivot point 116, which is about halfway between the first end 112 and the second end 116. However, the pivot point may be anywhere along a length of the leaf spring.

The slider box 104 couples to the vehicle through a coupler 122. For example, the slider-box coupler 122 may fixedly couple the slider box 104 directly to a frame of the vehicle, while still allowing the slider box 104 to pivot with regard to the vehicle. In another example, the slider-box coupler 122 may fixedly couple the slider box 104 indirectly to the frame via a hanger/shackle of the vehicle, while still allowing the slider box 104 to pivot with regard to the vehicle. In such a case, the hanger/shackle of the vehicle may be modified so that as the vehicle is loaded, the slider box is forced toward an axle of the vehicle (foreshortening the leaf spring, as discussed below).

Further, the slider box 104 includes an opening 124 that accepts the second end 114 of the leaf spring 102. As the leaf spring 102 flattens (i.e., the camber 118 lessens), the second end 114 of the leaf spring 102 slides within the slider box 104. The slider box 104 includes a foreshortening mechanism 126 that basically changes a length of a portion of the leaf spring between the second end of the leaf spring and the pivot point of the leaf spring as the leaf spring flattens.

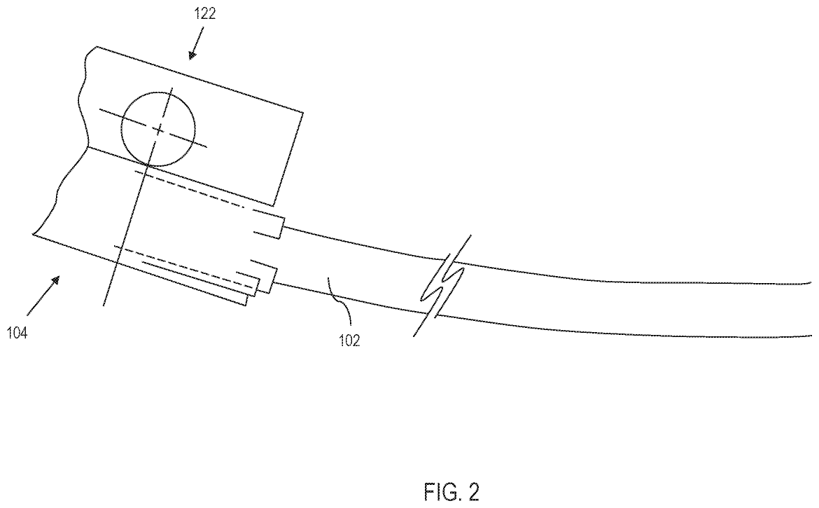

Turning now to FIG. 2, a close up of the slider box 104 and leaf spring 102 is shown. As discussed above, the slider box 104 couples to the vehicle via a coupler 122 such that the slider box 104 will not move other than rotational movement to compensate for the flattening camber of the leaf spring as any load of the vehicle increases.

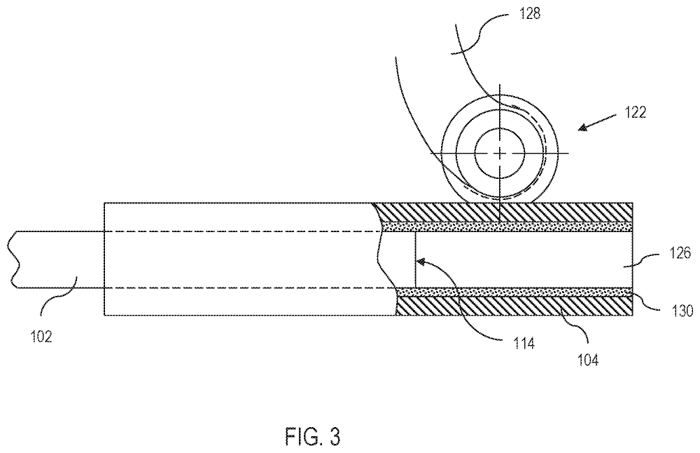

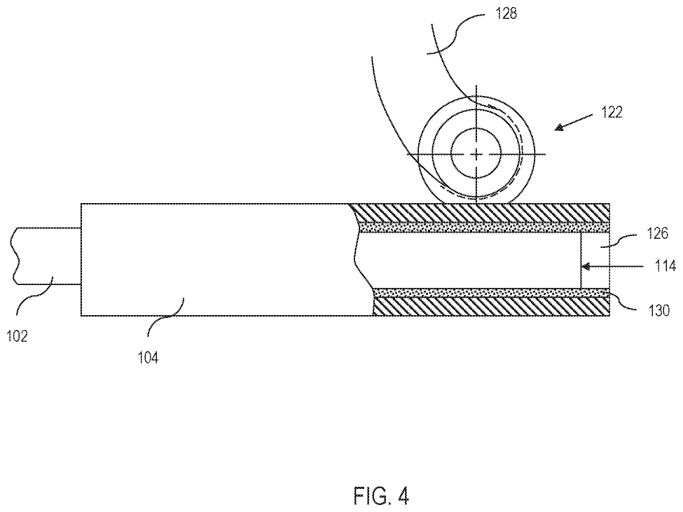

FIGS. 3 and 4 illustrate foreshortening of the leaf spring 102 within the slider box 104. Specifically, FIG. 3 illustrates the leaf spring 102 under a light load such that there is a less flat camber. The slider box 104 couples to the frame 112 of the vehicle via the coupler 122 and a shackle 128. However, as noted above, the slider box 104 may couple directly to the frame via the coupler 122 only.

Further, the second end 114 of the leaf spring 102 is only a portion of the way through the slider box 104, because there is only a light load on the vehicle. As the load increases, the leaf spring 102 flattens (and thus lengthens overall) extending into the slider box 104, as shown in FIG. 4. Note that the second end 114 of the leaf spring 102 in FIG. 4 is deeper into the slider box 104. In some embodiments, the slider box includes a stop that contacts a fixed point on the frame of the vehicle, which foreshortens the spring to a final length, which provides the highest spring rate for the leaf spring 102 within the suspension. Further, the spring rate may be changed by varying the location of the pivot point (116, FIG. 1) on the leaf spring 102.

To prevent wear and tear on the slider box 104 and leaf spring 102, the inside of the slider box 104, the second end 114 of the leaf spring 102, or both may be lined with a compounded plastic layer 130 (i.e., a protective layer). Further, the leaf spring 102 may include a diagonal slot that guides the leaf spring as the leaf spring flattens.

In the example case of FIGS. 3-4, the foreshortening mechanism 126 is a fluid (e.g., air, oil, etc.) that compresses to foreshorten the leaf spring 102. Thus, the slider box 104 acts as a cylinder and the second end 114 of the leaf spring 102 acts as a piston.

Therefore, depending on a ratio of the slider box (i.e., cylinder bore) to an amount the leaf spring 102 traverses within the slider box 104 (i.e., stroke), a mechanical advantage may be gained, which basically foreshortens the leaf spring 102 (and raises the spring rate of the leaf spring).

Another foreshortening mechanism 126 within the spring box 104 may include a mechanical mechanism such that as the leaf spring 102 flattens, the second end of the leaf spring acts as a lever to produce rotational movement of the slider box 104. In another foreshortening mechanism 126, the second end of the leaf spring 102 acts on the shackle 128 to move the shackle itself (similar to a Hotchkiss shackle) to foreshorten the spring. In yet another foreshortening mechanism 126, the slider box 104 may be encased in a larger box to foreshorten the leaf spring 102 as it flattens.

Moreover, in some embodiments, the shackle 128 includes a positioner that allows a user to adjust a position of the shackle in reference to the frame of the vehicle. For example, a shackle toward a front of the vehicle may be repositionable (e.g., in a transverse direction, rotatably, or both) such that repositioning the shackle results in the slider box changing a length of the leaf spring. For example, if the slider box is moved forward on the frame, a load carrying capacity of the leaf spring will increase. On the other hand, if the shackle is moved rearward on the frame, the ride of the leaf spring will soften. In embodiments with a repositionable shackle, the shackle may be positioned manually or automatically (e.g., by a motor, actuator, etc.).

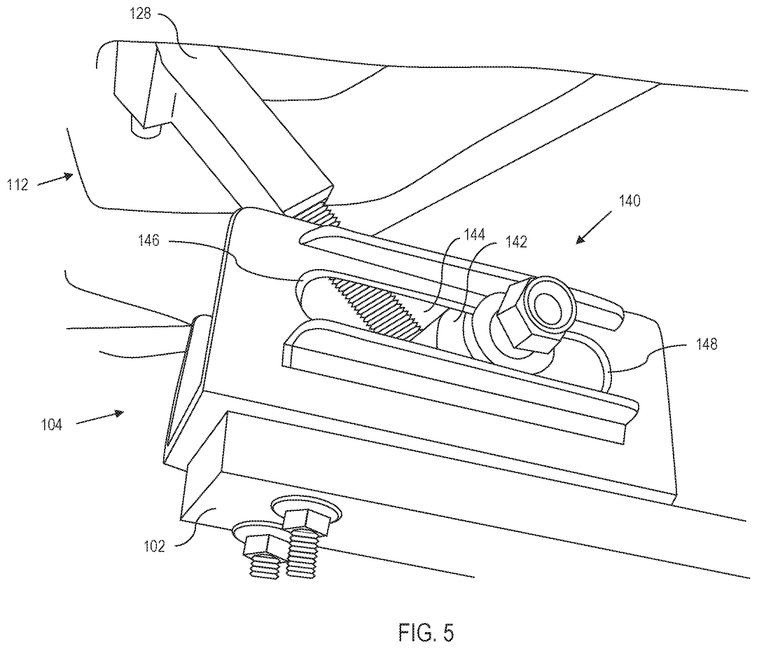

FIG. 5 illustrates a further embodiment of the slider box 104. In the embodiment of FIG. 5, the slider box 104 includes a roller mechanism 140 and couples to the vehicle frame 112 via a hangar/shackle 128. The roller mechanism 140 includes a wheel 142 that is free to rotate in an elongated aperture 144 of the slider box 104. In this embodiment, the leaf spring 102 is fixedly coupled to the slider box 104. As with the other leaf springs and slider boxes mentioned above, the leaf spring 102 and slider box 104 of the embodiment of FIG. 5 are both parts of a suspension system 100 in a vehicle (see FIG. 1).

When there is no load on the vehicle, there will be a minimum amount of force from the vehicle frame 112 on the leaf spring 102. Thus, the leaf spring will be at a maximum camber and the wheel 142 of the roller mechanism 140 will be toward a front end 146 of the elongated aperture 144. As more weight is added to the vehicle, more force is applied from the frame 112 through the hangar 128 to the leaf spring 102 via the roller mechanism 140 of the slider box 104. When this force is applied, the leaf spring 102 will start to flatten out (i.e., reduce in camber) and the hangar 128 pivots toward a back end 148 of the elongated aperture 144 such that the wheel 142 rolls toward the back end 148 of the elongated aperture 144. Thus, the effective length of the leaf spring 102 is shortened by the length that the wheel 142 rolls along the elongated aperture 144; therefore, the leaf spring 102 is effectively foreshortened.

When a maximum load is on the vehicle, the leaf spring 102 will flatten further (as described above) until the wheel 142 of the roller mechanism 140 reaches the back end 148 of the elongated aperture 144, which results in a maximum foreshortening of the leaf spring 102.

While only one wheel and elongated aperture are discussed above, the embodiment of FIG. 5 may also include a second wheel and a second elongated aperture (not shown) on another side of the hangar/shackle 128. The second wheel and second elongated aperture effectively mirror the description of the wheel 142 and elongated aperture 144 above. Thus, the slider box 104 can have two wheels and two elongated apertures, one on each side of the hangar/shackle 128.

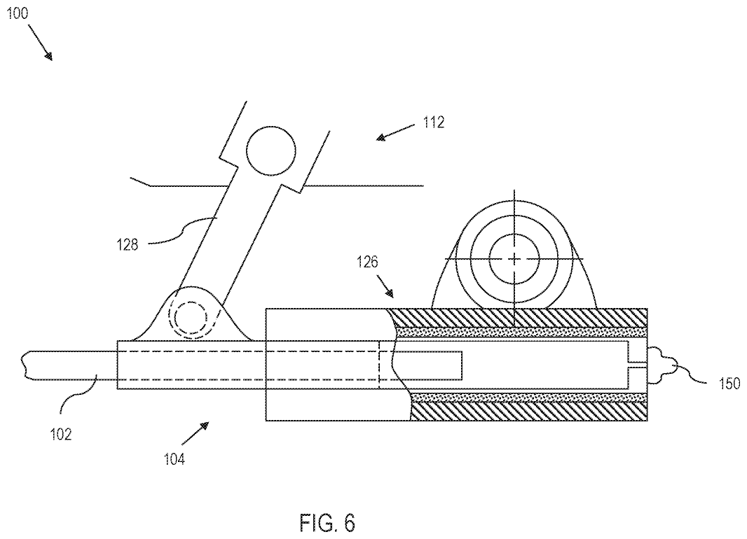

FIG. 6 illustrates a further embodiment of the variable-rate leaf spring suspension system 100 described herein. As with the embodiments listed above, the variable-rate leaf spring suspension system 100 includes a leaf spring 102 and a slider box 104 coupled to a frame 112 of a vehicle. A hangar/shackle 128 couples the slider box 104 such that when a heavier load is placed on the vehicle, the slider box 104 moves left (i.e., toward a back of the vehicle if the slider box is coupled to a front portion of the vehicle) and the spring effectively moves to the right (i.e., toward the front of the vehicle if the slider box is coupled to a front portion of the vehicle).

In embodiments that include a fluid-based foreshortening mechanism 126, the fluid-based foreshortening mechanism 126 is charged with fluid (e.g., oil, air, etc.) via a charging port 150. Adding more fluid to the fluid-based foreshortening mechanism 126 reduces the amount the leaf spring 102 may be foreshortened, while adding less more fluid to the fluid-based foreshortening mechanism 126 increases the amount the leaf spring 102 may be foreshortened. Therefore, the charging port 150 may be used to increase or decrease foreshortening, so a user of the vehicle may adjust ride and load characteristics of the suspension system as desired.

The suspension systems described herein include a leaf spring 102 and a slider box 104 at one end of the leaf spring 102. However, in some embodiments, there is a slider box 104 for each end of the leaf spring 102. Thus, in embodiments with two slider boxes for a leaf spring, the slider boxes 104 work similarly to the slider boxes described above. With such embodiments, the leaf spring may be shortened more than embodiments with just one slider box per leaf spring.

Further, in several embodiments of the variable-rate leaf spring suspension system, more than one foreshortening mechanism may be used in the slider box. For example, the slider box may include a roller mechanism and a fluid-based foreshortening mechanism.

Using the suspension systems described herein, the slider box in general may be used to create a variable spring rate leaf spring from a standard leaf spring by foreshortening the leaf spring as described above. Further, a ride quality of the vehicle may be changed by repositioning the shackle that couples the slider box to the frame, as described above (i.e., move the slider box rearward to soften the ride quality, move the slider box forward to lessen the softness of the ride quality).

Any of the components of the embodiments of the suspension systems described herein may be substituted with any of the components from other embodiments of the suspension systems described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A suspension system for a vehicle comprising:
a leaf spring comprising:
a first end with a first coupler that couples to a first point on a frame of a vehicle;
a second end;
a pivot point between the first end and the second end; and
a camber between the first end and the second end; and
a slider box comprising:
a coupler that fixedly couples the slider box to a second point on the frame of a vehicle;
an opening that accepts the second end of the leaf spring such that the leaf spring slides in the slider box when the leaf spring is flattened; and
a foreshortening mechanism that changes an effective length of a portion of the leaf spring between the second end of the leaf spring and the pivot point of the leaf spring as the leaf spring flattens.

2. The suspension system of claim 1, wherein the foreshortening mechanism of the slider box comprises a fluid that compresses to foreshorten the leaf spring as the leaf spring flattens.

3. The suspension system of claim 2, wherein the foreshortening mechanism further comprises a charge port that allows a user to add the fluid to the foreshortening mechanism.

4. The suspension system of claim 1, wherein the foreshortening mechanism of the slider box comprises a mechanical mechanism to foreshorten the leaf spring as the leaf spring flattens.

5. The suspension system of claim 1, wherein the foreshortening mechanism of the slider box is encased in a larger box that acts to foreshorten the leaf spring as the leaf spring flattens.

6. The suspension system of claim 1, wherein the foreshortening mechanism of the slider box comprises a roller mechanism comprising a wheel that interacts with an elongated aperture of the slider box.

7. The suspension system of claim 1, wherein the slider box further comprises a stop that limits an amount the leaf spring may flatten.

8. The suspension system of claim 1, wherein the leaf spring further comprises a protective layer that protects the leaf spring from abrasion while in use.

9. The suspension system of claim 1, wherein the second end of the leaf spring comprises a diagonal slot that guides the leaf spring as the leaf spring flattens.

10. A suspension system for a vehicle comprising:
a leaf spring comprising:
a first end with a first coupler for coupling the leaf spring to a first point on a frame of a vehicle;
a second end;
a pivot point between the first end and the second end; and
a camber between the first end and the second end; and
a slider box comprising:
a coupler for fixedly coupling the slider box to a second point on the frame of a vehicle;
an opening for accepting the second end of the leaf spring such that the leaf spring slides in the slider box when the leaf spring is flattened; and
a foreshortening mechanism for changing an effective length of a portion of the leaf spring between the second end of the leaf spring and the pivot point of the leaf spring as the leaf spring flattens.

11. The suspension system of claim 10, wherein the foreshortening mechanism of the slider box comprises a fluid that compresses to foreshorten the leaf spring as the leaf spring flattens.

12. The suspension system of claim 11, wherein the foreshortening mechanism further comprises a charge port that allows a user to add the fluid to the foreshortening mechanism.

13. The suspension system of claim 10, wherein the foreshortening mechanism of the slider box comprises a mechanical mechanism to foreshorten the leaf spring as the leaf spring flattens.

14. The suspension system of claim 10, wherein the foreshortening mechanism of the slider box is encased in a larger box that acts to foreshorten the leaf spring as the leaf spring flattens.

15. The suspension system of claim 10, wherein the foreshortening mechanism of the slider box comprises a roller mechanism comprising a wheel that interacts with an elongated aperture of the slider box.

16. The suspension system of claim 10, wherein the slider box further comprises a stop that limits an amount the leaf spring may flatten.

17. The suspension system of claim 10, wherein the leaf spring further comprises a protective layer that protects the leaf spring from abrasion while in use.

18. The suspension system of claim 10, wherein the second end of the leaf spring comprises a diagonal slot that guides the leaf spring as the leaf spring flattens.

19. A suspension system for a vehicle comprising:
a leaf spring comprising:
a first end;
a second end;
a pivot point between the first end and the second end; and
a camber between the first end and the second end;
a first slider box comprising:
a coupler that couples the slider box to a first point on the frame of a vehicle via a first hanger of the vehicle;
an opening that accepts the first end of the leaf spring such that the leaf spring slides in the first slider box when the leaf spring is flattened; and
a first foreshortening mechanism that changes an effective length of a portion of the leaf spring between the first end of the leaf spring and the pivot point of the leaf spring as the leaf spring flattens; and
a second slider box comprising:
a coupler that couples the slider box to a second point on the frame of a vehicle via a second hanger of the vehicle;
an opening that accepts the second end of the leaf spring such that the leaf spring slides in the second slider box when the leaf spring is flattened; and
a second foreshortening mechanism that changes an effective length of a portion of the leaf spring between the second end of the leaf spring and the pivot point of the leaf spring as the leaf spring flattens.

20. The suspension system of claim 19, wherein the first foreshortening mechanism of the first slider box comprises a roller mechanism comprising a wheel that interacts with an elongated aperture of the first slider box.
